(19) United States
(12) Patent Application Publication
(10) Pub. No.: US 2009/0049374 A1
(43) Pub. Date: Feb. 19, 2009

(54) ONLINE MAGAZINE

(76) Inventor: Andrew Echenberg, Ontario (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/186,721

(22) Filed: Aug. 6, 2008

Related U.S. Application Data
(60) Provisional application No. 60/935,503, filed on Aug. 16, 2007.

(51) Int. Cl. G06F 17/00; G06F 3/048; G06F 17/30

(52) U.S. Cl. 715/249; 715/243; 715/808; 707/1; 707/E17.001

(57) ABSTRACT

A system and method for creating a user generated magazine/newspaper is provided which increases the level of reader interaction, allows for increased viewership and lowers both production and distribution costs. The system provides and organizes content according to user actions with each magazine/newspaper as well as its hosted website. The system also includes a mechanism for posting comments, an approach for allowing the URL of a given article to change dynamically without prior bookmarked links, and finally access control features to enable certain individuals to have control and input into a given magazine/newspaper.

### CROSS-REFERENCE TO RELATED APPLICATIONS

The present application claims priority under 35 U.S.C. 119(e) of Provisional Patent Application bearing Ser. No. 60/935,503 filed on Aug. 16, 2007, the contents of which are hereby incorporated by reference.

### TECHNICAL FIELD

The present invention relates to the field of online magazines, and more specifically, to a dynamic, transplantable electronic magazine distributed over a network (e.g. Internet) as well as the given technology to produce one.

### BACKGROUND OF THE INVENTION

With the advent of personal computers, the growth of digital media and the influx of User Generated Content (UGC), User Generated Magazines will act as a new digital medium for mass collaboration and instantaneous distribution of User Generated Content.

As opposed to conventional paper magazines which require editorial control, absorb high distribution costs and offer only periodic releases, online user generated magazines will offer instantaneous distribution, active user engagement, real-time updates and only incur marginal distribution costs.

With today's technology, the time and effort required to build a magazine is extremely demanding. Tasks ranging from incorporating layouts, continually accommodating reader preferences and ensuring an overall high quality publication create a heavy workload as well as a complicated process for any individual and/or group.

This scenario is further compounded by the fact that gaining access to a wide viewership for one's content is very challenging. In the typical case, users have to spend a large portion of time dedicated to building up a viewership by posting links, sending out emails and promoting their site through other means (incl. advertising, interviews, reviews, etc.).

### SUMMARY OF THE INVENTION

There is described herein a dynamic, transplantable electronic magazine distributed over a network (e.g. Internet) as well as the given technology to produce one. The electronic magazine, due to its transplantable nature, is viewable from multiple websites thereby facilitating the reader experience and expanding potential readership.

In accordance with a first broad aspect, there is provided herein a dynamic electronic magazine that is distributed electronically to a subscriber via a network, the format of the magazine based on an algorithm that optimizes the magazine layout with respect to at least one of the following: Time Variables, User Preference Variables, Number of Photos, Number of Video Feeds, Number of Word Characters and size of the digital magazine.

In accordance with a second broad aspect, there is provided herein a system for providing a dynamic electronic magazine distributed electronically to a subscriber comprising: a server coupled to a network; a database accessible by the server; and an application coupled to the server. The application is configured for presenting a message thread of articles which appear in the electronic magazine and comments related to the articles by: graphically presenting an image indicative of a magazine article as part of a graphical user interface that is presented to a user on a display; launching a pop-up graphical list of user commands which includes an option to view comments as a result of receiving an article options command; and launching a pop-up graphical window containing a list of comments related to the magazine article as a result of receiving a view comments command.

In accordance with a third broad aspect, there is provided herein a system that allows users to alter the URL of their article while not breaking prior bookmarks to the given article page itself, the system comprising: a data table containing an article ID number; a data table containing an article ID and all given article post slugs; a data table containing an article ID and all given content for the article; and an application coupled to the server. The application is configured for: receiving the given article post slug embedded in a user's link; and retrieving the article I.D. associated with that Post Slug.

In one embodiment of the described implementation, the articles are graphically presented in HTML and Flash, among other formats. In the Flash format, the articles are presented in a manner that emulates that of an actual magazine where users flip through pages. In the HTML format, users simply click through the website to articles of specific interest to them.

The elements that are visible within the magazine include, but are not limited to, pictures, text, video, audio, number of votes per article, number of views per article, magazine index page and article options (whereby users can make comments, forward to other friends, post to favorites, print, etc).

In another embodiment, the magazine uses a combination of page views and user votes to determine the placement of articles inside the magazine. In this embodiment, the magazine may have two sections: a “most popular section” and a “recently submitted section”. The placement of articles in the “most popular section” is based on variables of popularity while the placement of articles in the “most recently submitted” section is based on the chronology of article submissions.

Magazine administrators can set rules for specific user activities. For instance, a first vendor can allow only specific users to write in his or her magazine while another vendor can set rules to allow any member to write in his or her magazine. These rule sets pertain not only to article submissions, but they may also pertain to voting, commenting, editing and administration, among other actions through the system's access controls.

If users wish to vote, comment and/or engage in other activities that directly affect the magazine, they can do so from the homepage of the magazine and/or from the transplantable magazine itself which can be hosted on other websites.

As soon as a user action is performed, whether it be voting, article submission, editing, etc., the magazine may automatically update to show the most current structure based on user preferences. This is reflected in the magazine's cover page, index page and article structure.

The system likewise allows users to alter the title of their articles without breaking any given bookmarks that have already been established with the article's URL (the Uniform Resource Locator “URL” is based on the article's title).

Throughout the specification, the term “Post Slug” should be understood to mean at least one word derived from an article title for use in permalinks (i.e. www.point.com/2007/04/03/my-article-title).

### BRIEF DESCRIPTION OF THE DRAWINGS

Further features and advantages of the present invention will become apparent from the following detailed description, taken in combination with the appended drawings, in which:

FIG. 1 is a diagram of an online magazine system in which an electronic magazine is constructed and distributed over a network to a given reader;

FIG. 2 illustrates the cover page of a dynamic online magazine as would be presented to a given reader;

FIG. 3 illustrates a magazine's Navigational Bar and inside pages including the index page and article pages;

FIG. 4A-4C are illustrations of the Article Options box as well as the Comment Option when it is activated from the given icon in FIG. 3;

FIG. 5 is a diagram outlining the variables used in determining the layout of a magazine;

FIG. 6 is an illustration of an access control system used by magazine administrators to determine the engagement privileges of various user groups; and

FIG. 7 is a diagram outlining the process by which article URLs are dynamically associated with article content to protect instances when bookmarks break as authors change the title of an article.

It will be noted that throughout the appended drawings, like features are identified by like reference numerals.

### DETAILED DESCRIPTION

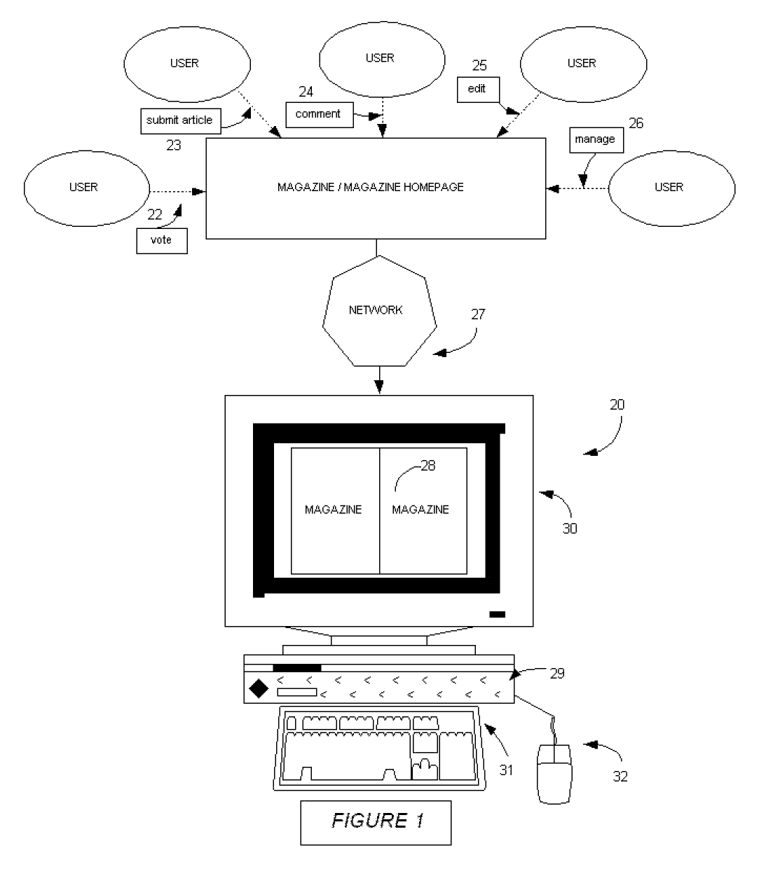

FIG. 1 shows an online magazine system 20 in which multiple users engage in various activities including but not limited to voting 22, submitting articles 23, commenting 24, editing 25, and managing content 26. The network 27 is preferably a data communications network, such as the Internet. The network can be implemented using wire-based and/or wireless technologies (e.g., cable, telephone, satellite, RF) as well as a combination of the two.

The viewer of the magazine has a computer comprising a central processing unit (CPU) 29, a monitor or display 30, a keyboard 31, and a mouse 32.

The magazine is distributed from the website's server over the network 27 in an electronic format. The digital magazine data is uploaded dynamically to the user's computer display 30 and presents itself in a multimedia environment which includes text, graphics, sound and video.

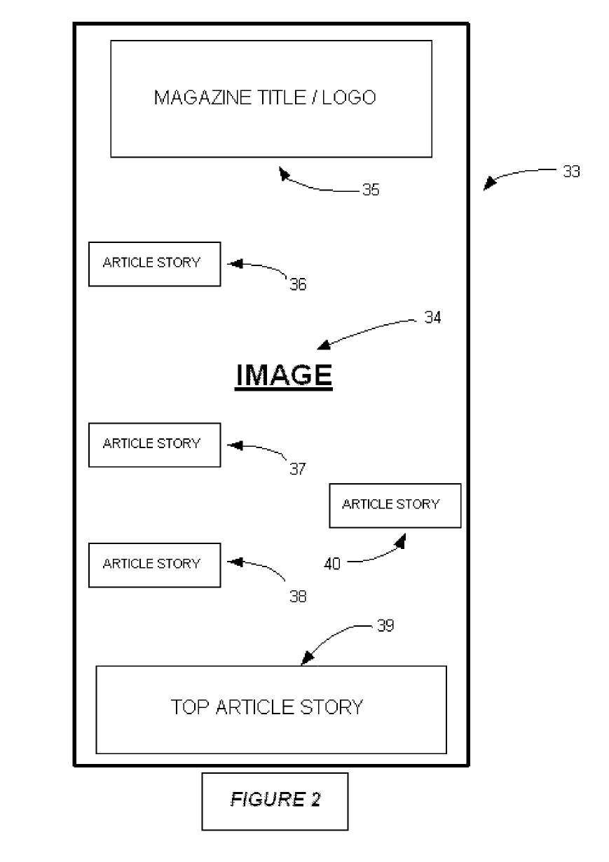

FIG. 2 illustrates the cover page of the magazine as it may be presented on the user's display 30. The cover page includes the magazine's Title/Logo 35, the title of the most popular article 39 as well as other article titles (36, 37, 38 and 40) within the magazine. In one embodiment, the cover page image 34 is the first photo of the most popular article in the given magazine. Should this photo not fit the parameters for the cover, automated settings will be in place to select an alternate one. Algorithms and programming techniques known by a person skilled in the art are used to implement this feature.

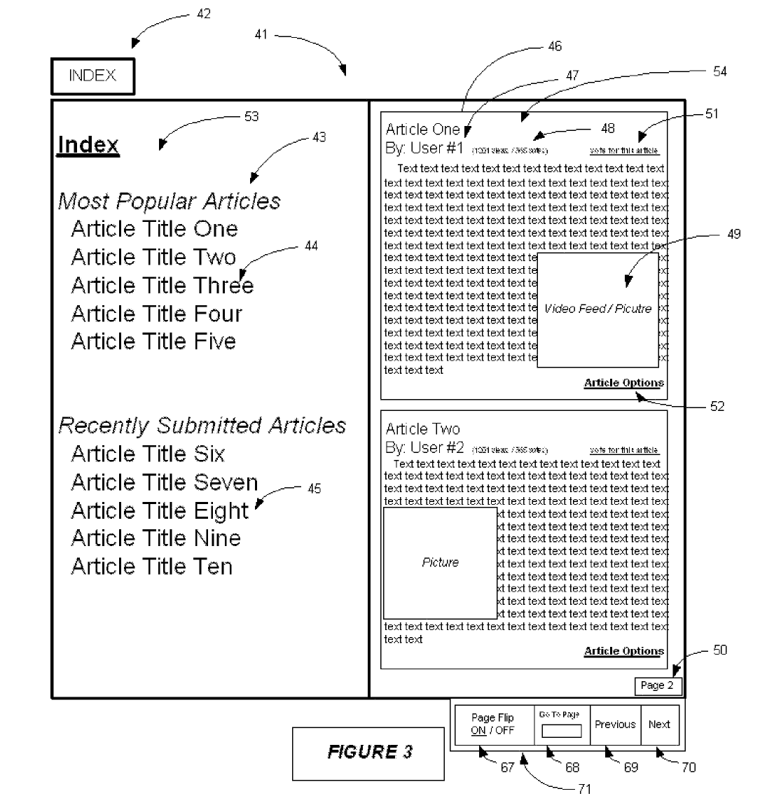

FIG. 3 represents the interior of the magazine interface 41, in this instance comprising the index page 53 and the first page of articles 54. The index page, as seen on the left hand side of FIG. 3 is comprised of a list 44 of the “Most Popular Articles” 43 at a given time followed by the “Most Recently Submitted Articles” with its ensuing list 45.

At the top left side of the magazine interface appears an Index Button 42, which if used, creates a drop down window with all of the magazine's contents listed inside. The button is visible on each page of the magazine and facilitates navigation of the interface.

Each link within this article box will either enable the users to engage in each given activity within the box itself or alternately be transferred back to the HTML site of the magazine where the user can engage in the same activities there.

On the right hand side of FIG. 3 appears the given articles of the magazine. Each article is presented with its given title 46, the author of the article 47, the number of votes and views for the article 48, as well as a video feed and/or picture 49. Each article likewise contains an active button 51 where users can vote for the article should they wish to do so.

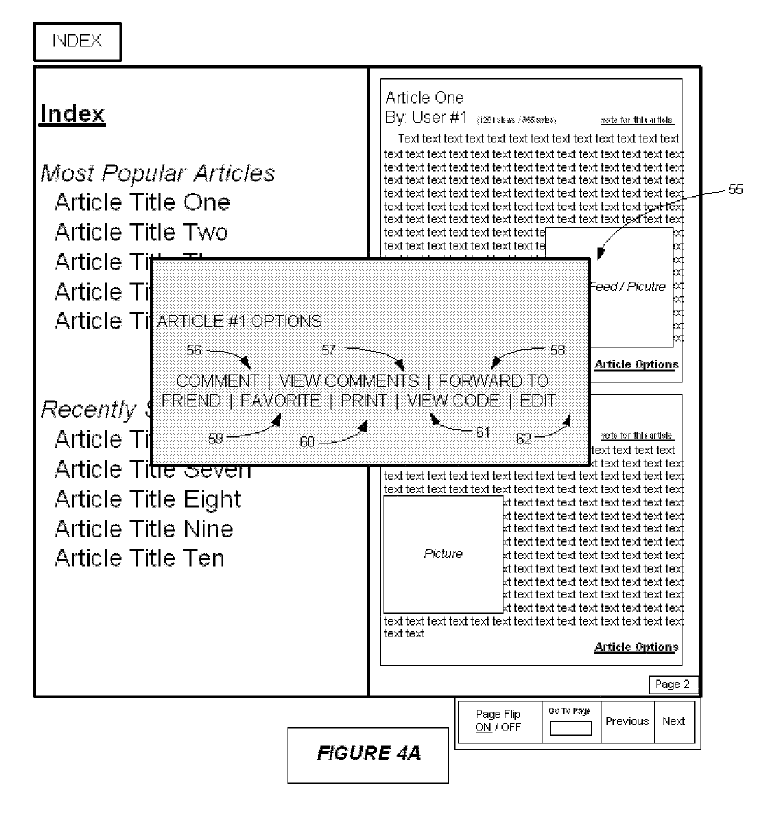

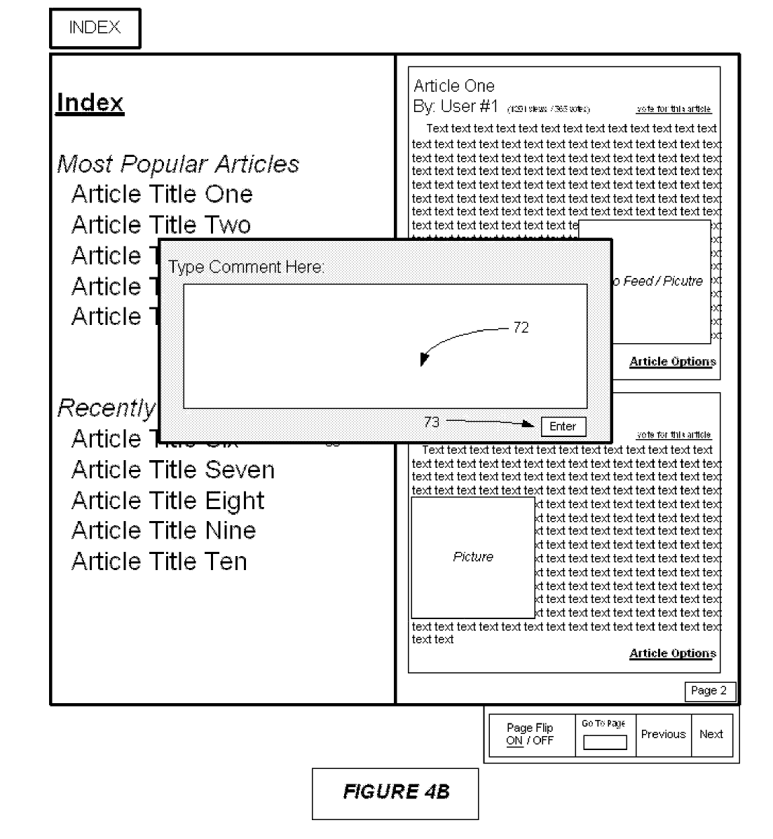

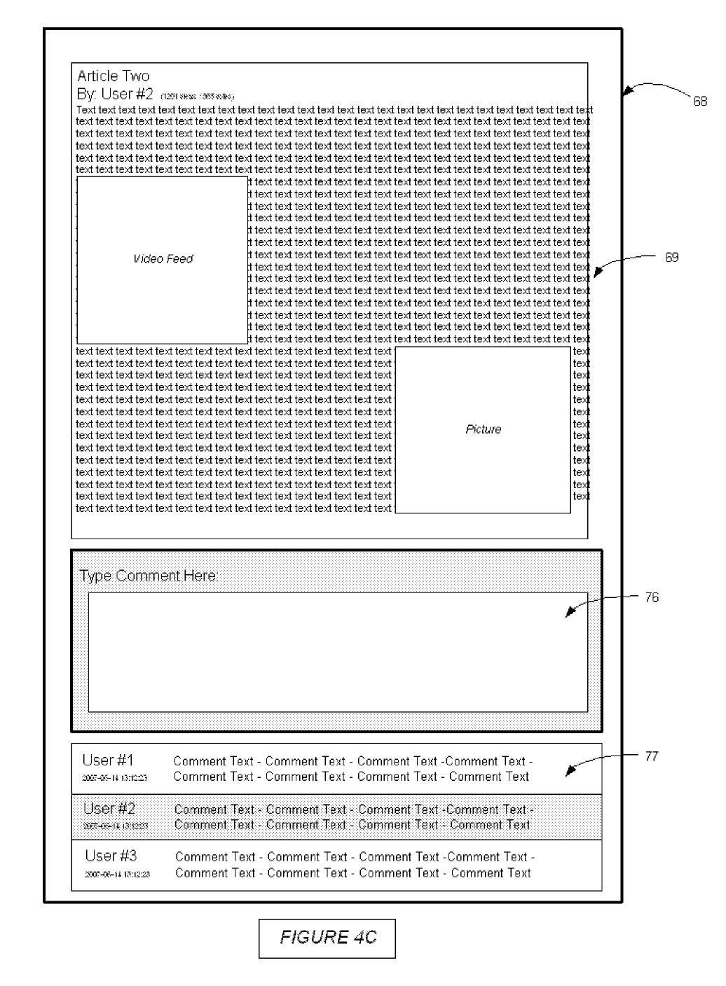

At the bottom of each article appears an “Article Options” link 52, which if activated, opens a window 55 as seen in FIG. 4. In the window the user is presented with a number of options from which to choose: comment on the article 56, view article comments 57, forward article to a friend 58, favorite the article (i.e. bookmark the article) 59, print the article 60, view the html code for the magazine 61 and edit the article 62.

If a user wishes to comment on a given article they can do so by clicking on the comment link 56, at which point the program will either open up a comment box as seen in FIG. 4B 72 where they can enter 73 their text directly or be transferred to the article's HTML version 68 as seen in FIG. 4C where a comment box 76 will be available below an article 69 and adjacent to the article's given comments 77. In either instance, once clicking on the comment option, the user will be directed to an interface where they will be able to insert their given comments.

Located below the magazine appears the magazine navigational bar 71. In this bar the user has the ability to turn on or off the page flipping mechanism 67, enter a page number they wish to visit 68, move back to the previous page 69 and/or move to the following page 70.

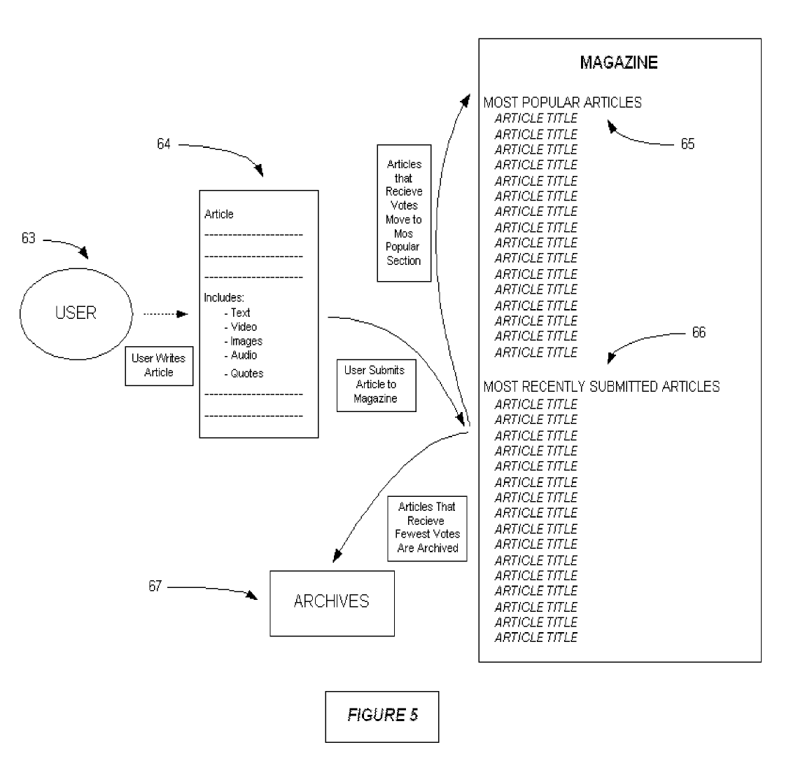

FIG. 5 illustrates how the magazine is constructed based on article submissions and voting. First, a user 63, writes an article which includes text, video, images, audio and quotes into a given magazine. The article is automatically submitted into the magazine's “Recently Submitted” Section 66. At this point, readers viewing the magazine can vote on a given article. If the given article garners enough votes it will move into the “Most Popular” Section 65 of the magazine. On the same token, if the article does not gain enough votes by the users, it will remain in the “Recently Submitted” Section 66 until new articles are submitted at which point it will be archived 67 and only viewable when searching through the magazine's archive database. The thresholds to make an article enter the “Most Popular” Section 65 or be removed from the “Recently Submitted” Section 66 are variable by an administrator of the system.

The construction of the magazine, due to its dynamic nature, may be based on the following variables: time, user preferences (i.e.: voting), chronology, number of photos, number of video feeds and number of word characters. An algorithm will take each article and sort it in the proper order within the given magazine (in the most popular section the placement is on popularity, and on the recently submitted section, it is based on chronology of submission). The algorithm will then layout each given article within its current slot based on the number of characters, videos and pictures that were contained inside to create a professional looking article layout.

This algorithm will take each entity within each given article and create an optimized layout in accordance with the aggregate number of input variables. For instance, an article containing two video feeds, 2500 characters and a 250×300 pixel photo would be laid out differently than an article with 1 video feed, 1000 characters and 3 100×150 pixel photos.

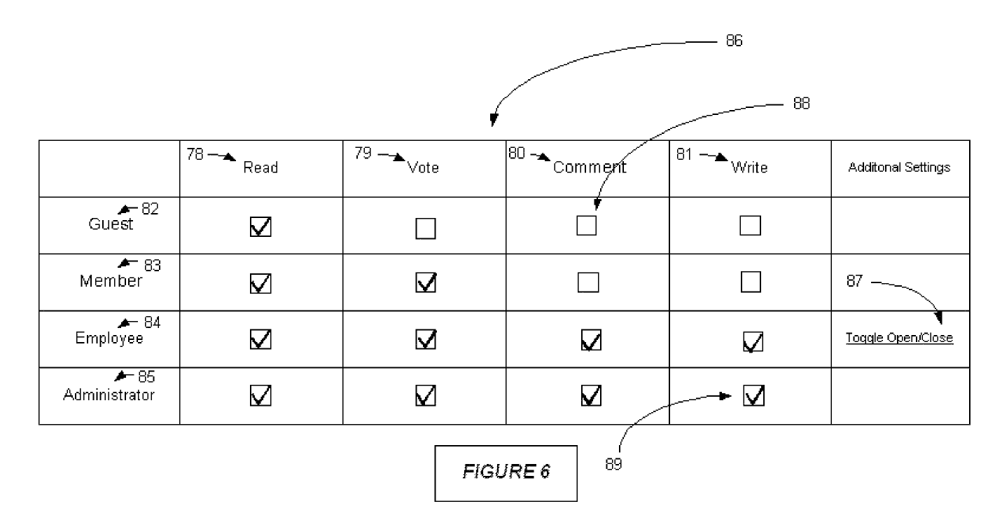

FIG. 6 illustrates an access control system 86 where magazine administrators can establish the rule sets for various user groups which include Guests 82, Community Members 83, Employees 84 and Administrators 85. With regard to actions, the magazine administrator can provide each group with the ability to read 78, vote 79, comment 80 and write 81. These controls can be enabled when a user checks 89 a blank box 88. The Toggle Open/Close Control 87 allows administrators to specify which users are classified as “employees” via an email domain specification, a csv. file upload or by inputting the individual email addresses.

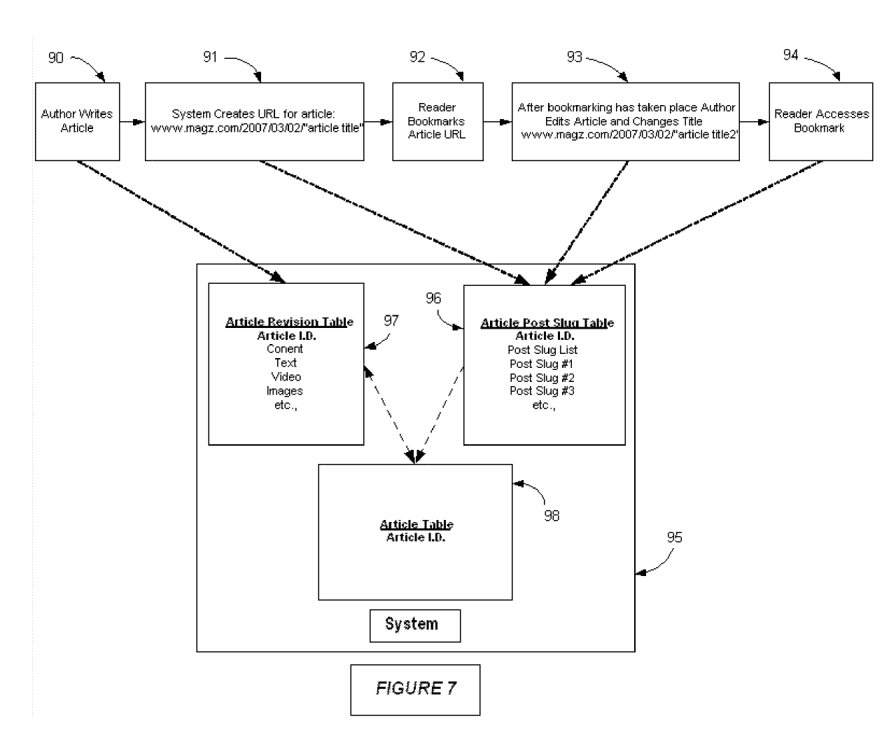

FIG. 7 illustrates a system 95 that enables authors to change the title of their article, in turn altering the article URL without breaking any bookmarks established by readers.

The system's framework is based on specific user actions. The user action of writing an article 90 has three implications: the first implication is the creation of a specific URL for the article based on the article's title 91, the second implication is the URL being listed in the system's data table for Article Post Slugs 96, and the third implication is that the given content of the article is entered into the system's data table for content 97. At this point a reader can bookmark the article with its associated URL 92. However, should the author of the article then change the article's title 93, it will alter the given URL but not break the bookmarks currently in place. This is accomplished by the system archiving all prior Post Slugs in the Article Post Slug Data Table 96 and associating them with the article's I.D.. The article I.D. is then matched with the article's content in the Article Revision Table via the main Article Data Table 98 in order to always post the most recent version of the Article. Through the master article listing table, the system would pull the necessary article content associated with the specified article I.D. and present it to the user.

As a result, when a reader clicks on a link of an article whose title has been edited 94, the system searches the list of Post Slugs in the Article Post Slug Table 96 to find the appropriate Article I.D. and through the Article's Main Table 98 pulls the most recent content of the Article, hosted on the Article Revision Table 97, onto the HTML page.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electromagnetic signal. The embodiments of the invention described above are intended to be exemplary only. The scope of the invention is therefore intended to be limited solely by the scope of the appended claims.

I/We claim:

1. A dynamic electronic magazine that is distributed electronically to a subscriber via a network, the format of the magazine based on an algorithm that optimizes the magazine layout with respect to at least one of the following: Time Variables, User Preference Variables, Number of Photos, Number of Video Feeds, Number of Word Characters and size of the digital magazine.

2. A dynamic electronic magazine as claimed in claim 1, wherein said format emulates that of an actual magazine.

3. A dynamic electronic magazine as claimed in claim 2, wherein said format allows said user to flip through said pages of said magazine similarly to doing so in said actual magazine.

4. A dynamic electronic magazine as claimed in claim 1, wherein a single article in said magazine comprises at least one of pictures, videos, text, and audio incorporated therein.

5. A dynamic electronic magazine as claimed in claim 1, wherein said format comprises a display of at least one of a number of votes received per article, a number of views per article, and a magazine index.

6. A dynamic electronic magazine as claimed in claim 1, wherein said format comprises a graphical user interface having a first section for most popular articles and a second section for recently submitted articles.

7. A dynamic electronic magazine as claimed in claim 1, wherein new magazine articles are accepted only when received from authorized users in accordance with a set of rules.

8. A dynamic electronic magazine as claimed in claim 1, wherein at least one of comments, votes, and editing of articles are accepted only when received from authorized users in accordance with a set of rules.

9. A dynamic electronic magazine as claimed in claim 1, wherein said format is automatically updated upon receipt of any one of comments, votes, editing of articles, and new articles.

10. A dynamic electronic magazine as claimed in claim 1, wherein an article title may be modified without altering a user bookmark using an unmodified title.

11. A dynamic electronic magazine as claimed in claim 1, wherein the magazine cover page is dynamically generated based on the popularity of content within the magazine.

12. A dynamic electronic magazine as claimed in claim 1, wherein the magazine layout is also based on voting of readership and members.

13. A dynamic electronic magazine as claimed in claim 1, wherein said magazine is a transplantable file that can be viewed on multiple websites.

14. A system for providing a dynamic electronic magazine distributed electronically to a subscriber comprising:
a server coupled to a network;
a database accessible by the server; and
an application coupled to the server, the application configured for presenting a message thread of articles which appear in the electronic magazine and comments related to the articles by:
graphically presenting an image indicative of a magazine article as part of a graphical user interface that is presented to a user on a display;
launching a pop-up graphical list of user commands which includes an option to view comments as a result of receiving an article options command; and
launching a pop-up graphical window containing a list of comments related to the magazine article as a result of receiving a view comments command.

15. A system as claimed in claim 14, wherein said graphically presenting an image comprises presenting an image that emulates that of an actual magazine.

16. A system as claimed in claim 15, wherein said application is configured to allow said user to flip through said pages of said magazine similarly to doing so in said actual magazine.

17. A system as claimed in claim 14, wherein said graphically presenting an image comprises providing at least one of pictures, videos, text, and audio incorporated into said magazine article.

18. A system as claimed in claim 14, wherein said application is further configured to display at least one of a number of votes received per article, a number of views per article, and a magazine index.

19. A system as claimed in claim 14, wherein said graphically presenting an image comprises placing said magazine article in one of two sections on said graphical user interface, a first section being for most popular articles and a second section being for recently submitted articles, said application being configured to determine which section said magazine article is to be presented in.

20. A system as claimed in claim 14, wherein said application is configured to receive new magazine articles for posting only from authorized users in accordance with a set of rules.

21. A system as claimed in claim 14, wherein said application is configured to receive at least one of comments, votes, and editing of articles only from authorized users in accordance with a set of rules.

22. A system as claimed in claim 14, wherein said application is configured to automatically update said graphical user interface upon receipt of any one of comments, votes, editing of articles, and new articles.

23. A system as claimed in claim 14, wherein said application is configured to allow an article title to be modified without altering a user bookmark using an unmodified title.

24. A system that allows users to alter the URL of their article while not breaking prior bookmarks to the given article page itself, the system comprising:
a data table containing an article ID number;
a data table containing an article ID and all given article post slugs;
a data table containing an article ID and all given content for the article;
an application coupled to the server, the application configured for:
receiving the given article post slug embedded in a user's link; and
retrieving the article I.D. associated with that Post Slug.
